(19) United States
(12) Patent Application Publication
(10) Pub. No.: US 2004/0042643 A1
(43) Pub. Date: Mar. 4, 2004

(54) Instant face recognition system

(75) Inventor: Alan Yeh, Taipei (TW)

Correspondence Address: BRUCE H. TROXELL, SUITE 1404, 5205 LEESBURG PIKE, FALLS CHURCH, VA, 22041, US

(73) Assignee: Symtron Technology, Inc.

(21) Appl. No.: 10/229,024

(22) Filed: Aug. 28, 2002

(51) Int. Cl. G06K 9/00

(52) U.S. Cl. 382/118

(57) ABSTRACT

An instant face recognition system includes at least an image capturing module for capturing images, a picture-taking direction control module coupling with the image capturing module for controlling picture-taking direction of the image capturing module to capture user's head images, a facial image processing module coupling with the image capturing module to detect user's facial features from user's head images captured by the image capturing module and compare the facial features to process recognition.

### FIELD OF THE INVENTION

The present invention relates to a face recognition system and particularly to an instant face recognition system with adjustable picture-taking direction.

### BACKGROUND OF THE INVENTION

With increasingly sophisticated development of information technology in recent years, information security has become more important than ever. In order to better protect information security, to restrict non relevant people from accessing information is essential and necessary. Identification recognition system is one of the mostly used methods to separate eligible or authorized people from the non eligible people to access the protected information.

At present, the commonly used identification recognition system is password. People who are authorized to access information have a password which allows the password owner to access selected information within the authorized scope. However passwords are easy to be compromised or stolen. To remedy this problem, some new and more sophisticated identification recognition systems have been developed, such as recognition systems for fingerprint, voice, iris, or face. Among them, the system that captures and recognizes people's features such as eyes, noses, mouths, face profiles is more popular. Because at an user end, it can function by employing only one video camera coupled with the matching software. In terms of equipment costs and user-friendliness, it provides more advantages than those for recognizing fingerprints, voices and irises.

Among conventional instant face recognition systems, ROC patent application No. 89115192 discloses a face recognition system based on people's face features. Its functional block diagram is shown in FIG. 1. As shown in FIG. 1, the face recognition system 2 consists of a video camera 4 and a computer 6. The computer 6 includes a video module 8, a face detection module 10, a facial features detection module 12, a face recognition module 14, a reference database 16 and an input/output module 18. The video camera 4 usually is installed on the computer 6 or in the vicinity of the computer 6 for capturing users' head images. The computer 6 is for processing images and database management.

The video module 8 receives users' heads images captured by the video camera 4. The reference database 16 stores a plurality of facial images for reference and comparison. The stored facial images are transferred in advance to Invariant space and are stored in the reference database 16 in Invariant faces formats. The face detection module 10 is coupled with the video module 8 for detecting facial areas in the head images. The facial features detection module 12 detects a plurality of facial features from the facial areas and transfers the facial features to the Invariant space to become an invariant vector.

The face recognition module 14 calculates the invariant vector of the facial features and similarity of the Invariant faces stored in the reference database 16, and based on the similarity to provide a confidence index. The input/output module 18 couples with a plurality of input or output devices, such as mouse, display devices, electric door locks, card readers, keyboards, sensors, and the likes to allow users to activate face recognition processes (such as sliding a card) and output results of the face recognition processes (such as open an electric door lock).

However the face recognition system and other known conventional instant face recognition systems have a common problem, i.e. the lens of the video camera is still and cannot be turned. Users have to turn their faces in front of the lens to have their face images taken by the video camera. As users' physical heights are different widely, for those users who have unusual physical heights such as very tall or very short, it could be very awkward and trying, such as standing on the toes or bending downwards, to put their faces in front of the still video camera lens.

It is obvious that to develop a face recognition system to overcome aforesaid problems is very important.

### SUMMARY OF THE INVENTION

Therefore the object of the invention is to provide an instant face recognition system with a video camera lens capable of adjusting picture-taking direction for rapidly and accurately pointing to users located in various directions to process face recognition.

The face recognition system of the invention processes face recognition based on user's face. The system includes an image capturing module for capturing images, a picture-taking direction control module coupling with the image capturing module for controlling picture-taking direction of the image capturing module to take user's head images, and a facial image processing module coupling with the image capturing module to detect user's facial features from user's head images captured by the image capturing module and compare the facial features to process recognition.

The image capturing module includes a video camera and a video driver to obtain RGB (Red, Green, Blue) original data of the head images. The picture-taking direction control module includes a motor coupling with the image capturing module to drive the picture-taking direction of the image capturing module, and a picture-taking direction adjustment module coupling with the motor for adjusting turning angle of the motor.

The facial image processing module includes at least: a storage module for storing a plurality of facial images for reference and comparing use, the stored facial images are transferred to Invariant spaces in advance and are stored in the storage module in formats of Invariant faces; a face detection module coupling with the image capturing module for detecting face image locations from the head images; a facial features detection module coupling with the face detection module for detecting a plurality of facial features from the face images and transferring every facial feature to Invariant spaces to become an Invariant vector; and a face recognition module for calculating the Invariant vectors of the face features and similarity degree of the Invariant faces stored in the storage module, and based on the similarity providing a confidence index.

The storage module includes an Invariant face database and an Invariant facial features database. The processes of calculating the Invariant vectors of the face features and similarity degree of the Invariant faces stored in the storage module are accomplished by employing Invariant Hadamard Transform algorithm or Invariant Critical Element Analysis. The face detection module is driven by an input module which includes mouse, electric door locks, card readers, sensors or a keyboards coupling with the face recognition system.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a functional block diagram of a conventional face recognition system.

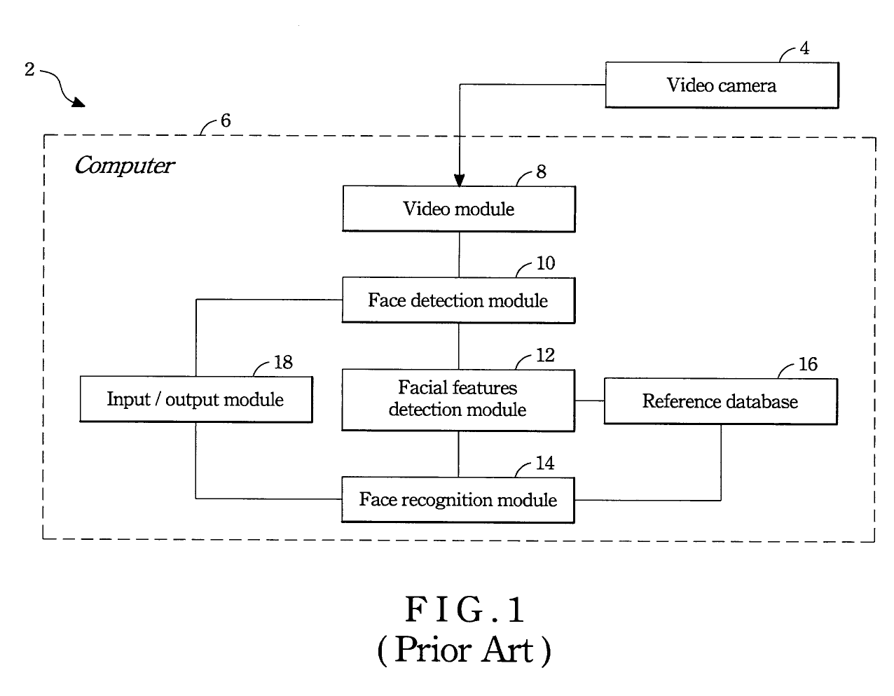

FIG. 2 is a functional block diagram of an embodiment of the face recognition system of the invention.

### DESCRIPTION OF THE PREFERRED EMBODIMENT

In view of conventional face recognition systems that employ a still video camera lens to capture face images and result in users have to face directly in front of the lens of the video camera for picture-taking, and could put users in awkward situations, such as standing on the toes or bending downwards, in the event of users' physical sizes do not match the elevation of the video camera lens, the invention aims at resolving the foregoing disadvantage by providing an instant face recognition system with a video camera lens that is capable of adjusting picture-taking directions and can rapidly and accurately turning to various directions to capture users' face images to process face recognition.

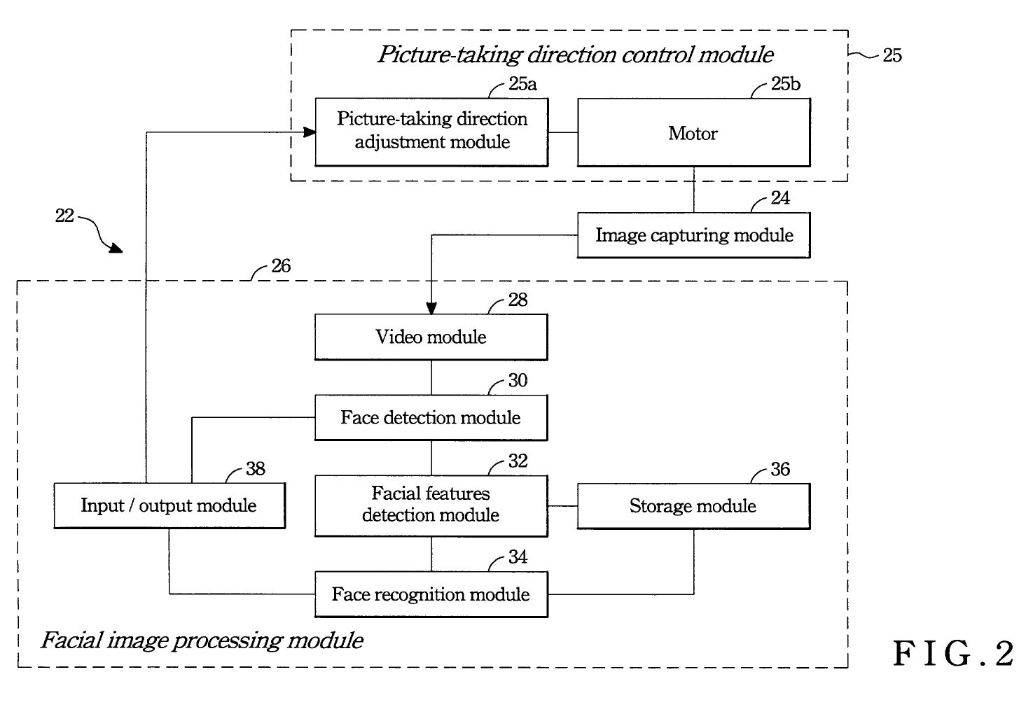

Refer to FIG. 2 for an embodiment of the invention. The face recognition system 22 of the invention includes at least: an image capturing module 24 for capturing images, a picture-taking direction control module 25 coupling with the image capturing module 24 for controlling picture-taking direction of the image capturing module 24 to take user's head images, a facial image processing module 26 coupling with the image capturing module 24 to detect user's facial features from user's head images captured by the image capturing module 24 and compare the facial features to process recognition.

The image capturing module 24 includes a video camera and a video driver to obtain RGB (Red, Green, Blue) original data of the head images. The picture-taking direction control module 25 includes a motor 25b (such as a step motor) coupling with the image capturing module 24 to drive the image capturing module 24 moving to desired picture-taking directions, and a picture-taking direction adjustment module 25a coupling with the motor 25b for adjusting turning angle of the motor 25b.

The facial image processing module 26 may be a computer including functions as those disclosed in ROC Patent Application No. 89115192. Specifically, the facial image processing module 26 may include: a video module 28, a face detection module 30, a facial features detection module 32, a face recognition module 34, a storage module 36 and an input/output module 38. The video module 28 couples with the image capturing module 24 for receiving users' head images captured by the image capturing module 24. The storage module 36 includes an Invariant face database and an Invariant facial features database for storing a plurality of facial images for reference and comparing use. In other words, the facial images stored in the storage module 36 are transferred to mathematical Invariant spaces in advance and are stored in the storage module 36 in formats of Invariant faces.

The face detection module 30 couples with the video module 28 for detecting face areas from the head images. The detection processes include: first, examine all possible objects of face areas in the head images; then based on Invariant Hadamard Transform algorithm or Invariant Critical Element Analysis to calculate the most possible objects of the face areas.

The facial features detection module 32 couples with the face detection module 30 and the storage module 36 for detecting a plurality of facial features from the face areas, and transferring every facial feature to Invariant spaces to become an Invariant vector. The facial features include eyes, noses, mouths, wrinkles on eye corners, and the likes. The face recognition module 34 couples with the facial features detection module 32 and the storage module 36 for comparing the detected facial features with the facial features stored in the Invariant face database and the Invariant facial features database, and calculating the Invariant vectors of the face features and similarity degree of the Invariant faces stored in the storage module 36, and based on the similarity provides a confidence index.

The input/output module 38 couples with a plurality of input or output devices, such as mouse devices, display devices, electric door locks, card readers, keyboards and the likes to allow users to activate the face recognition processes (such as sliding a card) or output face recognition results (such as opening an electric door lock).

Of course, before implementing the face recognition system of the invention, a training procedure is required. Reference for the training procedure can be found in ROC Patent Application No. 89115192. As it forms no part of the invention, details are omitted here. Operation of the face recognition of the invention, in addition to employing the picture-taking direction control module 25 to control picture-taking direction of the image capturing module 24 for capturing users' head images, processing procedures of the facial image processing module 26 after the image capturing module 24 has captured users' head images also can be found in ROC Patent Application No. 89115192.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A face recognition system for processing face recognition through an user's face, comprising at least:
an image capturing module for capturing images;
a picture-taking direction control module coupling with the image capturing module to control picture-taking direction of the image capturing module to capture user's head images;
a storage module for storing a plurality of facial images for reference and comparing use, the stored facial images having been transferred to mathematical Invariant spaces in advance and being stored in the storage module in formats of Invariant faces;
a face detection module coupling with the image capturing module for detecting locations of facial images from the head images;
a facial features detection module coupling with the face detection module for detecting a plurality of facial features from the facial images, and transferring every facial feature to Invariant spaces to become an Invariant vector; and
a face recognition module for calculating Invariant vectors of the facial features and similarity degree of the Invariant faces stored in the storage module, and based on the similarity providing a confidence index.

2. The face recognition system of claim 1, wherein the image capturing module includes a video camera and a video driver to obtain RGB (Red, Green, Blue) original data of the head images.

3. The face recognition system of claim 1, wherein the picture-taking direction control module includes:
a motor coupling with the image capturing module to drive the picture-taking direction of the image capturing module; and
a picture-taking direction adjustment module coupling with the motor for adjusting turning angle of the motor.

4. The face recognition system of claim 1, wherein the storage module includes an Invariant face database and an Invariant facial features database.

5. The face recognition system of claim 1, wherein the calculating Invariant vectors of the facial features and similarity degree of the Invariant faces stored in the storage module are accomplished by employing Invariant Hadamard Transform algorithm or Invariant Critical Element Analysis.

6. The face recognition system of claim 1, wherein the face detection module is driven by an input module.

7. The face recognition system of claim 6, wherein the input module couples with the face recognition system and is selected from the group consisting of mouse devices, electric door locks, card readers or keyboards.

8. A face recognition system for processing face recognition through an user's face, comprising at least:
an image capturing module for capturing images;
a picture-taking direction control module coupling with the image capturing module to control picture-taking direction of the image capturing module to capture user's head images; and
a facial image processing module coupling with the image capturing module for detecting user's facial features from the user's head images captured by the image capturing module and processing recognition for the facial features;

9. The face recognition system of claim 8, wherein the image capturing module includes a video camera and a video driver to obtain RGB (Red, Green, Blue) original data of the head images.

10. The face recognition system of claim 8, wherein the picture-taking direction control module includes:
a motor coupling with the image capturing module to drive the picture-taking direction of the image capturing module; and
a picture-taking direction adjustment module coupling with the motor for adjusting turning angle of the motor.

11. The face recognition system of claim 8, wherein the facial image processing module includes at least:
a storage module for storing a plurality of facial images for reference and comparing use, the stored facial images having been transferred to mathematical Invariant spaces in advance and being stored in the storage module in formats of Invariant faces;
a face detection module coupling with the image capturing module for detecting locations of facial images from the head images;
a facial features detection module coupling with the face detection module for detecting a plurality of facial features from the facial images, and transferring every facial feature to Invariant spaces to become an Invariant vector; and
a face recognition module for calculating Invariant vectors of the facial features and similarity degree of the Invariant faces stored in the storage module, and based on the similarity providing a confidence index.

12. The face recognition system of claim 11, wherein the storage module includes an Invariant face database and an Invariant facial features database.

13. The face recognition system of claim 11, wherein the calculating Invariant vectors of the facial features and similarity degree of the Invariant faces stored in the storage module are accomplished by employing Invariant Hadamard Transform algorithm or Invariant Critical Element Analysis.

14. The face recognition system of claim 11, wherein the face detection module is driven by an input module.

15. The face recognition system of claim 14, wherein the input module couples with the face recognition system and is selected from the group consisting of mouse devices, electric door locks, card readers, sensors or keyboards.
